(19) United States
(12) Patent Application Publication
(10) Pub. No.: US 2021/0025831 A1
(43) Pub. Date: Jan. 28, 2021

(54) LID DETECTING SYSTEM AND LID DETECTING METHOD

(71) Applicant: CVC TECHNOLOGIES, INC., Taichung City (TW)

(72) Inventors: Chi-Huan SHIH, Taichung City (TW); Chia-Kai CHANG, Taichung City (TW); Chang-Cheng CHEN, Taichung City (TW)

(21) Appl. No.: 16/517,682

(22) Filed: Jul. 22, 2019

(51) Int. Cl. G01N 21/90; B65B 57/14; B65B 57/02; G01N 35/10

(52) U.S. Cl. CPC G01N 21/90; G01N 35/1011; B65B 57/02; B65B 57/14

(57) ABSTRACT

A lid detecting system includes a first lid screwing device, a second lid screwing device, a scanning device and a removing device. The first lid screwing device is configured for positioning a lid of a container on a body of the container and rotationally tightening the lid of the container to the body of the container by a pre-screwing torque. The second lid screwing device is configured for rotationally tightening the lid of the container to the body of the container by a screwing torque. The scanning device is disposed between the first lid screwing device and the second lid screwing device and configured for scanning a top surface of the lid of the container so as to obtain a detecting value. The removing device is configured for removing the container when the detecting value is greater than a predetermined value.

### BACKGROUND

### Technical Field

The present disclosure relates to a lid detecting system and a lid detecting method. More particularly, the present disclosure relates to a lid detecting system and a lid detecting method for detecting the position of the lid of the container.

### Description of Related Art

Nowadays, packaging of containing products is one of important manufacturing step in automatic production field. In the application of the automatic production system, not only the yield of the products should be satisfied, but the high efficiency of the manufacturing procedure is also should be achieved.

### SUMMARY

According to one aspect of the present disclosure, a lid detecting system includes a first lid screwing device, a second lid screwing device, a scanning device and a removing device. The first lid screwing device is configured for positioning a lid of a container on a body of the container and rotationally tightening the lid of the container to the body of the container by a pre-screwing torque. The second lid screwing device is configured for rotationally tightening the lid of the container to the body of the container by a screwing torque. The scanning device is disposed between the first lid screwing device and the second lid screwing device and configured for scanning a top surface of the lid of the container so as to obtain a detecting value. The removing device is configured for removing the container when the detecting value is greater than a predetermined value.

According to another aspect of the present disclosure, a lid detecting method includes a first lid screwing step, a detecting step, a calculating step, a second lid screwing step and a removing step. In the first lid screwing step, a lid of a container is positioned on a body of the container. In the detecting step, a scanning device detects the lid of the container so as to generate a detecting signal. In the calculating step, the scanning device transmits the detecting signal to a controlling unit, and the controlling unit converts the detecting signal into a detecting value and determines whether the detecting value is greater than a predetermined value. In the second lid screwing step, the lid of the container is rotationally tightened to the body of the container. In the removing step, the container is removed when the detecting value is greater than the predetermined value.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a lid detecting system according to one embodiment of the present disclosure.

FIG. 2 is a top view of the lid detecting system according to the embodiment of FIG. 1.

FIG. 3 is a side view of the lid detecting system according to the embodiment of FIG. 1.

FIG. 4 is a block diagram of a lid detecting method according to another embodiment of the present disclosure.

### DETAILED DESCRIPTION

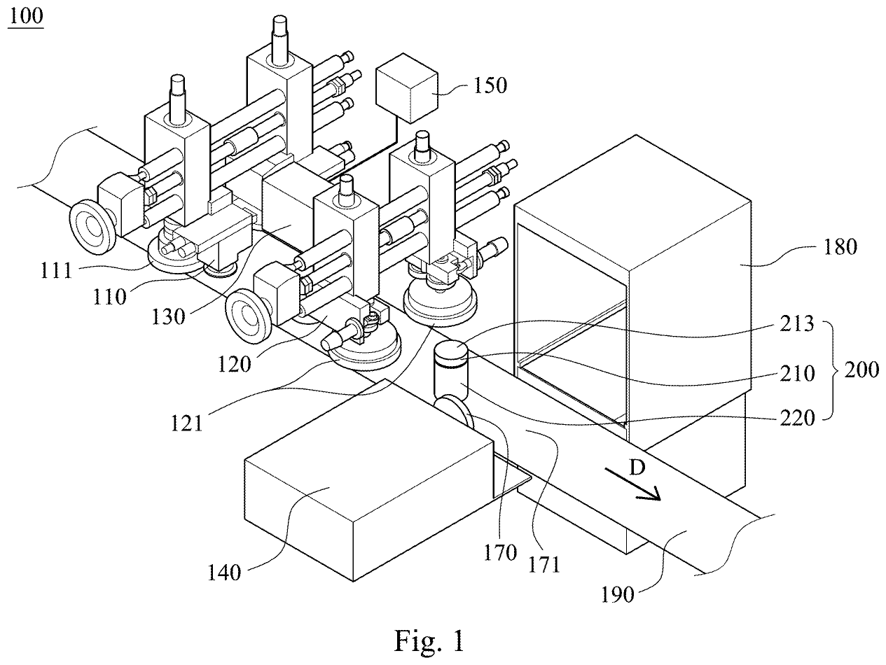

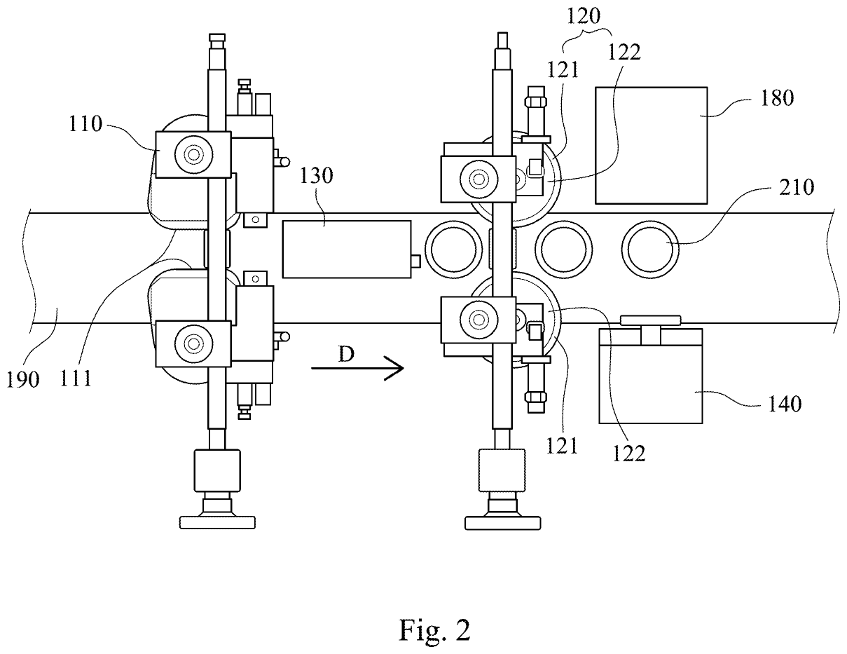

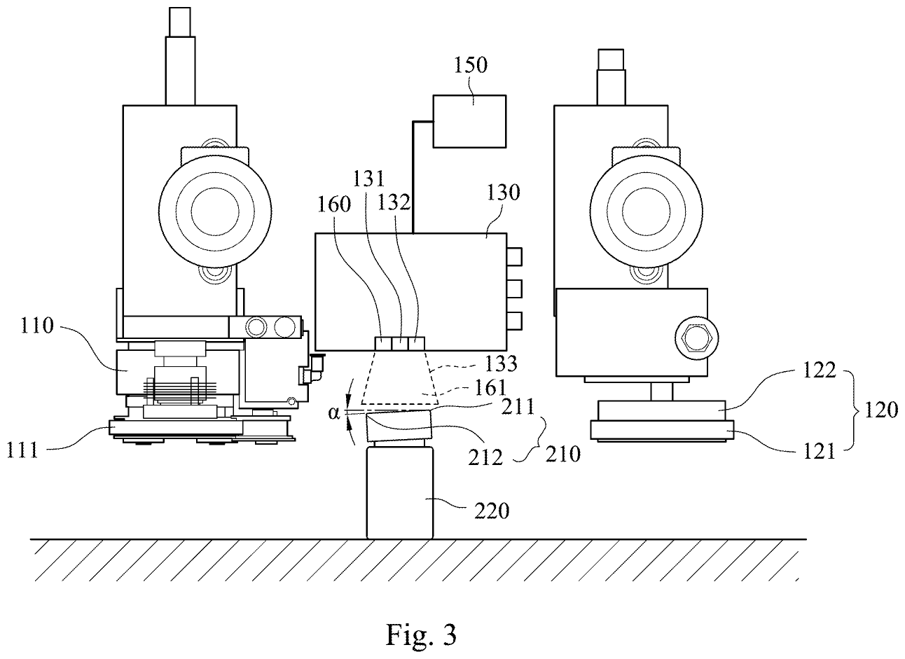

Please refer to FIG. 1, FIG. 2 and FIG. 3. FIG. 1 is a schematic view of a lid detecting system 100 according to one embodiment of the present disclosure. FIG. 2 is a top view of the lid detecting system 100 according to the embodiment of FIG. 1. FIG. 3 is a side view of the lid detecting system 100 according to the embodiment of FIG. 1. According to the embodiment of the present disclosure in FIG. 1, a lid detecting system 100 includes a first lid screwing device 110, a second lid screwing device 120, a scanning device 130 and a removing device 140.

The first lid screwing device 110 is configured for positioning a lid 210 of a container 200 on a body 220 of the container 200 and rotationally tightening the lid 210 of the container 200 to the body 220 of the container 200 by a pre-screwing torque. The second lid screwing device 120 is configured for rotationally tightening the lid 210 of the container 200 to the body 220 of the container 200 by a screwing torque. The scanning device 130 is disposed between the first lid screwing device 110 and the second lid screwing device 120 and is configured for scanning a top surface 213 of the lid 210 of the container 200 so as to obtain a detecting value. The removing device 140 is configured for removing the container 200 when the detecting value is greater than a predetermined value.

The lid detecting system 100 of the present disclosure can be applied to an automatic production system (not shown), and the container 200 can be packaged and manufactured on the automated production system. With the aforementioned structure, the lid detecting system 100 can automatically detect the packaged state of the container 200 and remove the container 200 with the lid 210 which is skewed with the body 220, so as to improve the yield of the container 200 during the automatic production system. Moreover, the container 200 can be transported by a conveyor belt 190 along a transporting direction D in sequence through the first lid screwing device 110, the scanning device 130, the second lid screwing device 120 and the removing device 140. When the lid detecting system 100 is applied with other systems, the conveyor belt 190 can be connected with other systems and transport the container 200 thereto.

At first, the body 220 of the container 200 can be put on the conveyor belt 190 and transported to the first lid screwing device 110. The first lid screwing device 110 can include a positioning unit 111 configured for applying the pre-screwing torque to rotationally tighten the lid 210 of the container 200 to the body 220 of the container 200. In detail, the first lid screwing device 110 can put the lid 210 on the body 220 and the positioning unit 111 applies the pre-screwing torque on the lid 210 to screw the lid 210 to the body 220 but not tight thereto, that is, the lid 210 would not be completely screwed to the body 220 by the positioning unit 111.

Then, the body 220 with the lid 210 thereon can be transported to the second lid screwing device 120, wherein the second lid screwing device 120 can provide the screwing torque for rotationally tightening the lid 210 to the body 220. Due to the accuracy of the lid 210 put on the body 220 by the first lid screwing device 110 will affect the tightening accuracy providing from the second lid screwing device 120, the scanning device 130 is provided between the first lid screwing device 110 and the second lid screwing device 120 for determining whether the lid 210 is put on the body 220 at a proper position.

In detail, the lid detecting system 100 can further include a controlling unit 150. The controlling unit 150 is signally connected to the scanning device 130 and the removing device 140, and is configured for determining whether the detecting value is greater than the predetermined value. That is, the scanning device 130 can scan the top surface 213 of the lid 210 of the container 200 for generating a detecting signal, and the controlling unit 150 is provided for converting the detecting signal into the detecting value and determining whether the detecting value satisfies the predetermined value or not. Further, the controlling unit 150 can be a PC (Program Counter) or PLC (Programmable Logical Controller) with computing functions, but the present disclosure will not be limited thereto.

As shown in FIG. 3, the scanning device 130 can include a light transmitter 131 and a light receiver 132. The light transmitter 131 emits a detecting light 133 to the top surface 213 of the lid 210 and the detecting light 133 can be reflected by the top surface 213, so as to generate a reflected light (not shown). The light receiver 132 is configured for receiving the reflected light. In the embodiment of FIG. 3, the scanning device 130 can be a CCD (Charge-Coupled Device) scanner, but the present disclosure will not be limited thereto. In detail, the scanning device 130 can be a plane-scanning CCD scanner, but the present disclosure will not be limited thereto. That is, the light transmitter 131 is a plane light source. When the plane light from the plane light source emits on the top surface 213 of the lid 210, the plane light emits on the whole top surface 213 and is reflected thereby as the reflected light, that is, the plane light emits on each point of the top surface 213, the light receiver 132 can receive the reflected light and generate the detecting signal. The detecting signal can include the information of the top surface 213 of the lid 210, such as a position of a highest point 211 of the top surface 213, a position of a lowest point 212 of the top surface 213, a relative position between the highest point 211 and the lowest point 212, an image of the top surface 213 of the lid 210, etc.. Therefore, the information on the whole top surface 213 can be scanned and it is favorable for precisely detecting the lid 210 on the body 220.

In order to determine the position of the lid 210 on the body 220 is proper or not, the controlling unit 150 converts the detecting signal into the detecting value. The detecting value can be an angle a between a horizontal plane and a line connecting the highest point 211 of the top surface 213 of the lid 210 and the lowest point 212 of the top surface 213 of the lid 210. The angle a can represent the tilt degree of the lid 210 on the body 220. When the detecting value is greater than the predetermined value, that is, the angle a is larger than a predetermined angle, and it means that the lid 210 on the body 220 is at an improper position and will not be correctly tightened by the second lid screwing device 120. That is, the container 200 with the detecting value greater than the predetermined value would be a defective container and should be removed. It should be mentioned that the detecting value and the predetermined value can also be defined as the distance value between the two points on the top surface 213 which will not be limited to the disclosure herein.

When the detecting value is greater than the predetermined value, the controlling unit 150 determines that the container is defective, and the removing device 140 will be driven to remove the container. When the detecting value is equal to or smaller than the predetermined value, the controlling unit 150 determines that the container is qualified. Therefore, it is favorable for ensuring that only the qualified container 200 would be transported to the next procedure.

In FIGS. 1 and 3, the lid detecting system 100 can further include a first position sensor 160. The first position sensor 160 is signally connected to the scanning device 130, wherein the first position sensor 160 drives the scanning device 130 to scan the top surface 213 of the lid 210 when the first position sensor 160 detects the container 200 into a predetermined detecting range 161.

In detail, the first position sensor 160 is disposed between the first lid screwing device 110 and the second lid tightening device 120. After the lid 210 is positioned on the body 220 by the first lid screwing device 110, the container 200 is transported along the transporting direction D. Once the container 200 is transported into the predetermined detecting range 161, the first position sensor 160 drives the scanning device 130 to scan the top surface 213 of the lid 210. Hence, the scanning device 130 would not be powered when there is no container in the predetermined detecting range 161 which is favorable for saving energy.

Please refer to Table 1, Table 1 shows detecting values of five containers provided by the lid detecting system 100 according to the embodiment of FIG. 1. In this embodiment, the predetermined value can be a value of an angle, and is set to be 1°, but the present disclosure is not limited thereto. When the detecting value of the container 200 is greater than 1°, the controlling unit 150 determines the container 200 is defective. When the detecting value of the container 200 is equal to or smaller than 1°, the controlling unit 150 determines the container 200 is qualified.

TABLE 1

| Container No. | 1 | 2 | 3 | 4 | 5 |
|---|---|---|---|---|---|
| Detecting | 7.215° | 22.345° | 10.231° | 0.356° | 0.198° |
| value | | | | | |
| defective | defective | defective | defective | qualified | qualified |
| or | | | | | |
| qualified | | | | | |

As shown in Table. 1, each detecting value of the container No. 1, the container No. 2 and the container No. 3 is greater than 1°, that is, the container No. 1, the container No. 2 and the container No. 3 would be removed by the removing device 140. Each detecting value of the container No. 4 and the container No. 5 is smaller than 1°, that is, the container No. 4 and the container No. 5 are qualified.

In FIG. 2, the second lid screwing device 120 can include a tightening unit 121 and a torque detecting unit 122. The tightening unit 121 is configured for applying the screwing torque to rotationally tightening the lid 210 of the container 200 to the body 220 of the container 200, further, the screwing torque can be a force feedback from the lid 210. The torque detecting unit 122 is signally connected to the controlling unit 130 and configured for determining whether the lid 210 is tightened to the body 220. Further, the torque detecting unit 122 can be set a predetermined torque, when the screwing torque provided by the tightening unit 121 is equaled to the predetermined torque, it means that the lid 210 is surely tightened to the body 220.

Furthermore, the second lid screwing device 120 can be signally connected to the controlling unit 150 and the container 200 with the detecting value is greater than the predetermined value would not be detected by the torque detecting unit 122. That is, the screwing torque of the defective container would not be detected after the container 200 screwed by the second lid screwing device 120 so as to increase the entire assembling efficiency.

Furthermore, the lid detecting system 100 can further include a second position sensor 170. The second position sensor 170 is signally connected to the controlling unit 150, wherein when the second position sensor 170 detects the container 200 with the detecting value which is greater than the predetermined value in a predetermined removing range 171, the removing device 140 is driven to remove the container 200 via the controlling unit 150.

In FIG. 1, the lid detecting system 100 can further include a recycling tank 180 which is disposed relative to the predetermined removing range 171. The defective container can be removed by the removing device 140 into the recycling tank 180. Thus, it is favorable for collecting and reusing the defective containers.

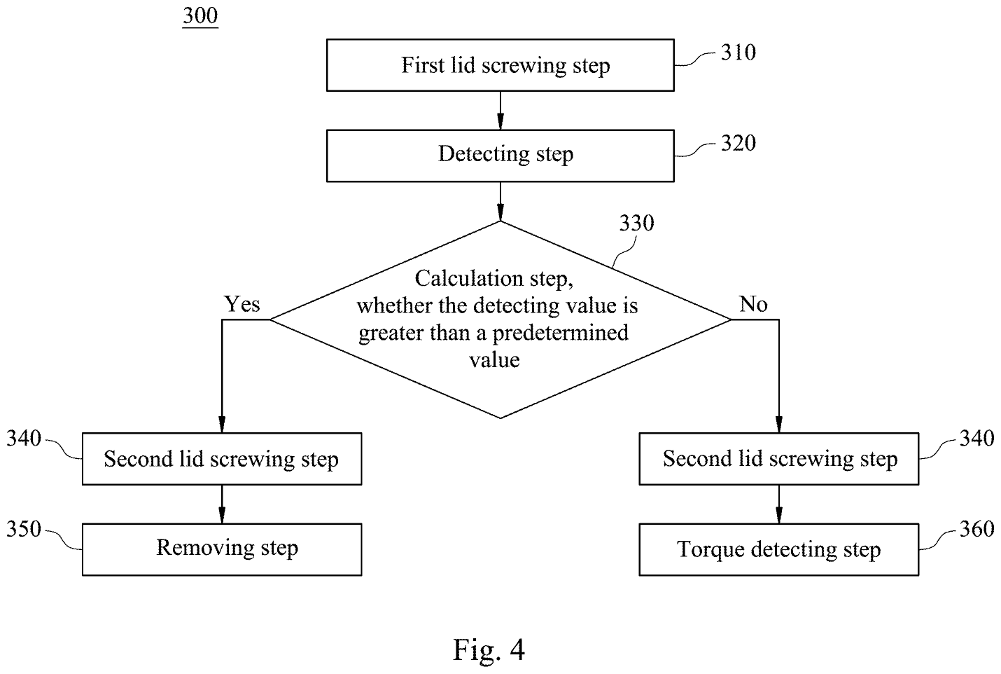

FIG. 4 is a block diagram of a lid detecting method 300 according to another embodiment of the present disclosure. The lid detecting method 300 includes a first lid screwing step 310, a detecting step 320, a calculating step 330, a second lid screwing step 340 and a removing step 350.

The lid detecting method 300 can be applied to the aforementioned lid detecting system 100, and the detailed description of the lid detecting method 300 can refer to the drawing and number of the embodiment of FIG. 1 to FIG. 3. However, the present disclosure is not limited thereto.

In the first lid screwing step 310, the lid 210 of the container 200 is positioned on the body 220 of the container 200. In the detecting step 320, the scanning devices 130 detecting the lid 210 of the container 200 so as to generate a detecting signal. As shown in the embodiment of FIG. 1, the top surface 213 of the lid 210 can be detected. In the calculating step 330, the scanning device 130 transmits the detecting signal to the controlling unit 150, and the controlling unit 150 converts the detecting signal into a detecting value and determining whether the detecting value is greater than a predetermined value. In the second lid screwing step 340, the lid 210 of the container 200 is rotationally tightened to the body 220 of the container 200.

In the removing step 350, the container 200 is removed when the detecting value is greater than the predetermined value.

In detail, as shown in the embodiment of FIG. 3, the detecting value can be the angle a between the horizontal plane and the line connecting the highest point 211 of the top surface 213 of the lid 210 and the lowest point 212 of the top surface 213 of the lid 210, but the present disclosure is not limited thereto. Depending on different situations, the type of the detecting value and predetermined value can be changed.

The lid detecting method 300 further includes a torque detecting step 360. In the torque detecting step 360, the container 200 with the detecting value equal to or smaller than the predetermined value can be detected for confirming the lid 210 is tightened to the body 220 or not.

In detail, in the second lid screwing step 340, the lid 210 is rotationally tightened by a screwing torque, and the torque detecting step 360 is configured for detecting whether the screwing torque is equal to a predetermined torque, further, the screwing torque can be a force feedback from the lid 210. When the screwing torque is equal to the predetermined torque, it means that the lid 210 is tightened to the body 220. Therefore, it is favorable for reconfirm the container 200 is qualified with product standards. Moreover, only the container 200 with the detecting value equal to or smaller than the predetermined value can be detected, that is, the screwing torque of the defective container would not be detected after the second lid screwing step 340 so as to increase the entire assembling efficiency.

In another embodiment, the removing step 350 can be performed before the second lid screwing step 340, that is, the container with the detecting value greater than the predetermined value can be removed and the lid thereof would not be rotationally tightened by the screwing torque, but the present disclosure is not limited thereto.

Therefore, it is favorable for increasing the efficiency of the packaging process of the container 200 and improving the yield of the container 200 by the lid detecting system 100 and the lid detecting method of the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A lid detecting system, comprising:
a first lid screwing device configured for positioning a lid of a container on a body of the container and rotationally tightening the lid of the container to the body of the container by a pre-screwing torque;
a second lid screwing device configured for rotationally tightening the lid of the container to the body of the container by a screwing torque;
a scanning device disposed between the first lid screwing device and the second lid screwing device and configured for scanning a top surface of the lid of the container so as to obtain a detecting value; and
a removing device configured for removing the container when the detecting value is greater than a predetermined value.

2. The lid detecting system of claim 1, further comprising:
a positioning unit configured for applying the pre-screwing torque to rotationally tightening the lid of the container to the body of the container.

3. The lid detecting system of claim 1, further comprising:
a controlling unit signally connected to the scanning device and the removing device, the controlling unit configured for determining whether the detecting value is greater than the predetermined value.

4. The lid detecting system of claim 1, further comprising:
a first position sensor signally connected to the scanning device, wherein the first position sensor drives the scanning device to scan the top surface of the lid when the first position sensor detects the container in a predetermined detecting range.

5. The lid detecting system of claim 3, wherein the scanning device comprises:
a light transmitter emitting a detecting light to the top surface of the lid and generate a reflected light; and
a light receiver configured for receiving the reflected light.

6. The lid detecting system of claim 5, wherein the scanning device generates a detecting signal while receiving the reflected light and transmits the detecting signal to the controlling unit, and the controlling unit converts the detecting signal into the detecting value.

7. The lid detecting system of claim 6, wherein the detecting value is an angle between a horizontal plane and a line connecting a highest point of the top surface of the lid and a lowest point of the top surface of the lid.

8. The lid detecting system of claim 5, wherein the scanning device is a CCD scanner.

9. The lid detecting system of claim 3, wherein the second lid screwing device comprises:
a tightening unit configured for applying the screwing torque to rotationally tightening the lid of the container to the body of the container; and
a torque detecting unit signally connected to the controlling unit and configured for determining whether the lid is tightened to the body.

10. The lid detecting system of claim 9, wherein the container with the detecting value is greater than the predetermined value would not be detected by the torque detecting unit.

11. The lid detecting system of claim 3, further comprising:
a second position sensor signally connected to the controlling unit, wherein when the second position sensor detects the container with the detecting value which is greater than the predetermined value in a predetermined removing range, the removing device is driven to remove the container via the controlling unit.

12. A lid detecting method, comprising:
a first lid screwing step, wherein a lid of a container is positioned on a body of the container;
a detecting step, wherein a scanning device detects the lid of the container so as to generate a detecting signal;
a calculating step, wherein the scanning device transmits the detecting signal to a controlling unit, and the controlling unit converts the detecting signal into a detecting value and determines whether the detecting value is greater than a predetermined value;
a second lid screwing step, wherein the lid of the container is rotationally tightened to the body of the container; and
a removing step, wherein the container is removed when the detecting value is greater than the predetermined value.

13. The lid detecting method of claim 12, further comprising:
a torque detecting step, wherein the container with the detecting value equal to or smaller than the predetermined value can be detected for confirming the lid is tightened to the body or not.

14. The lid detecting method of claim 12, wherein the detecting value is an angle between a horizontal plane and a line connecting a highest point of the top surface of the lid and a lowest point of the top surface of the lid.
